(19) United States
(12) Patent Application Publication
(10) Pub. No.: US 2004/0149891 A1
(43) Pub. Date: Aug. 5, 2004

(54) Alignment method of the optical transmitter and receiver in the optical wireless communication system

(76) Inventors: Kyuman Cho, Seoul (KR); Youngwan Choi, Seoul (KR); Heeseong Jeong, Seoul (KR)

Correspondence Address: FLESHNER & KIM, LLP, P.O. BOX 221200, CHANTILLY, VA, 20153, US

(21) Appl. No.: 10/469,519

(22) PCT Filed: Jan. 3, 2002
(86) PCT No.: PCT/KR02/00006

(51) Int. Cl. H01J 40/14

(52) U.S. Cl. 250/214 R

(57) ABSTRACT

Infrared ray detecting board which is able to observe the intensity, size and shape of the laser light from the transmitter and to separate the laser light of the transmitter from the external infrared rays to confirm the arriving position of the laser light to the receiver at the transmitter side directly, and LED indicator for corresponding the center of the laser light to the photo-detecting region of the receiver are provided. Moreover, various alignment methods using such devices and an alignment device having removable motor are provided.

### TECHNICAL FIELD

The present invention relates to an apparatus and method for aligning a transmitter and receiver in the optical wireless communication system, more particularly, to an apparatus for observing an arrived position of a laser light to the receiver directly at the transmitter side, an alignment method for aligning the transmitter and receiver using thereof, and an aligner.

### RELATED ART

A process of aligning a transmitter and receiver is required to construct the optical wireless communication system so that the receiver can exactly receive a laser light from the transmitter. A prior alignment method that has been used in the optical wireless communication system has below steps.

a) Setting equipments temporarily to be opposite each other with a telescope or a sight telescope.

b) Observing an arrived position of a laser light from the transmitter at the receiver side with IR viewer.

c) Moving the transmitter with a screw or a motor until the laser light from the transmitter is observed at the receiver side.

d) Indicating the position of the laser light with radio transmitter at the receiver side if the laser light of the transmitter is observed.

e) Moving the laser light to a light reception unit of the receiver according to the indication of the receiver.

f) Fixing the transmitter and receiver if the center of the laser light corresponds to the light reception unit.

In the prior method, a wavelength of a light source generally used is the infrared ray band. In this case, one can observe the laser light of the other side with an infrared ray viewer.

However, if one observes the laser light with the infrared ray viewer for a long time, his eyes become to be fatigued. Moreover, one has difficulty in observing wide region, because observation region is limited to a moving distance of his eyes.

Moreover, alignment speed is slow, and corresponding the center of the laser light to the light reception unit of the receiver exactly is difficult, because the transmitter cannot align itself without the indication of the receiver.

Furthermore, in the prior alignment method, drivers such as screw or motor, etc. are mounted on an aligner. In case of the screw, manufacture is difficult, and a unit cost of manufacture becomes to be high because the detailed degree of screw line has to be very high. Moreover, in case of the motor, not only price of the motor that has specific rotation angle and enough rotary power reaches decuple of that of a unit cost of manufacturing aligner excepting a motor, but also the aligner is difficult to be miniature and light owing to large volume and heavy weight of the motor.

As above-mentioned, it takes a lot of time that the transmitter and receiver are aligned by the prior alignment method. Moreover, corresponding the center of the laser light to the light reception unit of the receiver is very difficult. Furthermore, there are problems that volume and weight of the aligner are large, and the price is high owing to the motor or screw for driving the transmitter and receiver.

### DETAILED DESCRIPTION OF THE INVENTION

An object of the present invention is to provide a method and apparatus for aligning a transmitter and receiver easily, and rapidly, in the optical wireless communication system.

Another object is to provide a method for manufacturing an aligner used to align a transmitter and receiver in the optical wireless communication system, to be small, light, and cheap.

In order to accomplish the objects, the present invention provides a light detection apparatus and a light strength indication apparatus used to align a transmitter and receiver, and an alignment method for aligning a transmitter and receiver with these apparatus, by a manual method, an automatic method, and a mixed method. Moreover, the present invention provides an aligner which is small, light, and cheap, by forming a driver to attachable and removable.

According to an embodiment of the present invention, a light detection apparatus comprises a board, a plurality of light detectors for detecting light from the outside of the board, wherein the light detectors are formed on the board, a plurality of LEDs (light-emitting diodes) for receiving a signal which indicates strength of a light which is detected by the light detectors and indicating it visually, wherein the LEDs are formed on the board.

The LEDs may be connected to the light detectors, respectively. Moreover, the light detection apparatus preferably comprises a plurality of amplifiers for converting current signals outputted from the light detectors to voltage signals, respectively and/or a plurality of demodulation circuits for converting only signals of predetermined frequency to direct current signals, and the amplifiers and/or the demodulation circuits are connected between the light detectors and the LEDs, respectively. The amplifiers and/or the demodulation circuits are preferably formed at the opposite side of a side where the light detector and the LEDs are formed.

The light detectors preferably make a pair with the LEDs, respectively, and, each the light detector and the LED that make a pair, is preferably arranged with a lattice form.

A light strength indication apparatus according to an embodiment of the present invention, comprises a reception terminal for inputting an electric signal from the outside, and a plurality of LEDs for indicating strength of the signal received through the reception terminal. The number of lightened LEDs are verified in proportion to the strength of the signal received through the reception terminal, and the reception terminal can receive the light strength signal from the light receiver by connecting to a power monitoring terminal of an optical receiver used in an optical the wireless communication system, and can receive.

The LEDs are arranged in a line, and the LEDs are mounted in a case for making surround of the LEDs be darker than the outside of the light strength indication apparatus. Moreover, the LEDs preferably comprise 2 or more LEDs that can indicate at least 2 colors.

An alignment method for aligning a transmitter and receiver in the optical wireless communication system according to an embodiment of the present invention, comprises the steps of corresponding a position of the receiver where a light outputted from the transmitter is arrived, to a light reception unit of the receiver, roughly, by detecting the position of the receiver from brightness distribution of first diodes with a light detection apparatus comprising a board, a plurality of light detectors for detecting light from the outside of the board, wherein the light detectors formed on the board, and a plurality of first LEDs for receiving a signal which indicates strength of the light detected by the light detectors and indicating it visually, wherein the first LEDs are formed on the board, and corresponding a center of a laser light from the transmitter to the light reception unit of the receiver, by detecting the center of the laser light from the number of second LEDs which are lightened, with a light strength indication apparatus comprising a reception terminal for inputting electric signals from a light strength detection terminal by connecting to the light strength detection terminal of the receiver, a plurality of second LEDs for indicating strength of the signal received through the reception terminal, wherein the number of second LEDs are lightened is verified in proportion to the strength of the signal received through the reception terminal.

In the first step, a position of the light detector corresponding to the first LED that is brightest of the plurality of first LEDs is detected as the position of the receiver where the laser light from the transmitter is arrived. In the second step, a position of the laser light is detected as the center of the laser light, when most number of the second LEDs is lightened.

Another alignment method comprises the steps of designating an injection range, interval, and speed of a laser light from the transmitter, transmitting the signal indicating strength of the light to the computer, as injection is started by designated injection range, intervals, and speed, judging whether the laser light from the transmitter is received to the receiver, storing an injection position and received signal value in case that the laser light is received to the receiver, judging whether reception of the laser light is discontinued, discontinuing injection in case that reception of the laser light is judged to be discontinued in the fifth step of judging, determining a position where the received signal value is peak of received signals between the injection position stored in the fourth step and the injection discontinued position in the sixth step, and moving the transmitter to the position where the received signal value is peak.

After the seventh step of determining, the alignment method may further comprise the step of judging whether the position where the received signal value is peak is at an edge of the injection region, and the step of re-designating the injection region, when the position where the received signal value is peak is at an edge, to adjacent to the edge of the injection range comprising the position where the received signal value is peak, and repeating the second step to the eighth step.

Moreover, in the third step the laser light from the transmitter is judged to be received to the receiver in case that the light strength indication signal exceeds a predetermined value, and in the fifth step the reception of the laser light is judged to be discontinued in case that the light strength indication signal is below a predetermined value.

Still another alignment method according to an embodiment of the present invention comprises the steps of corresponding a position of the receiver where a laser light from the transmitter is arrived, to a light reception unit of the receiver, roughly, and determining a predetermined range comprising the position by detecting the position of the receiver through brightness distribution of first diodes by using a light detection apparatus comprising a board, a plurality of light detectors, formed on the board, for detecting a light from the outside of the board, and a plurality of first LEDs, formed on the board, for receiving a signal indicating strength of the light detected by the light detectors and indicating the signal visually, transmitting the signal indicating strength of the laser light received to the receiver to the computer, as injection is started to the injection range which is determined by the first step, with predetermined injection intervals, and speed, judging whether the laser light from the transmitter is received to the receiver, storing the injection position and received signal value in case that the laser light is received to the receiver, judging whether reception of the laser light is discontinued, discontinuing injection in case that reception of the laser light is discontinued, determining position where the received signal value is peak of the received signals between the injection position stored in the fourth step and the injection discontinued position in the sixth step, and moving the transmitter to the position where the received signal value is peak.

An aligner according to an embodiment of the present invention, may comprise a holder for the transmitter and receiver, and means for moving the transmitter and receiver, wherein the means is disposed to verify and fix a position of the holder to a predetermined direction, wherein the means for moving the transmitter and receiver further comprises means for fixing a connection unit for connecting with an external driver and the position of the holder, and wherein the position of the holder can be verified to a predetermined direction by using the driver in the state of being connected to the external driver by the connection unit, and wherein the driver may be removed after fixing the holder by using the means for fixing the connection unit.

The means for moving the transmitter and receiver may be not less than two, and the predetermined direction may be up and down, or right and left.

### BRIEF DESCRIPTION OF THE DRAWINGS

FIG. 1a shows an entire construction of an infrared ray detection board according to an embodiment of the present invention.

FIG. 1b shows an enlarged view of the area A shown in FIG. 1a.

FIG. 1c shows a block diagram of a circuit formed in the infrared ray detection board according to an embodiment of the present invention.

FIG. 2 shows a construction of a LED indicator according to an embodiment of the present invention.

FIG. 3 shows a flowchart of a manual alignment method according to an embodiment of the present invention.

FIG. 4 shows a flowchart of an automatic alignment method according to an embodiment of the present invention.

FIG. 5 is a conception view for illustrating an injection method of an aligner used in an embodiment of the present invention.

FIG. 6 shows a flowchart of a mixed alignment method according to an embodiment of the present invention.

FIG. 7 shows a construction of an aligner whose driver is attachable and removable according to an embodiment of the present invention.

### EMBODIMENTS

With referring to the drawings, preferred embodiments of the present invention will be described in the following.

The alignment method for aligning an optical transmitter and receiver according to the present invention can be widely classified to a) a manual alignment method, b) an automatic alignment method, c) a mixed alignment method of the manual and automatic alignment methods. The main characteristic of these alignment methods is that the transmitter can be aligned directly with confirming a position of the laser light arrived in the receiver without an indication of the receiver side.

In the present invention, an infrared ray detection board comprising a light detector and a LED, and a LED indicator is proposed as equipment for observing the position of the laser light.

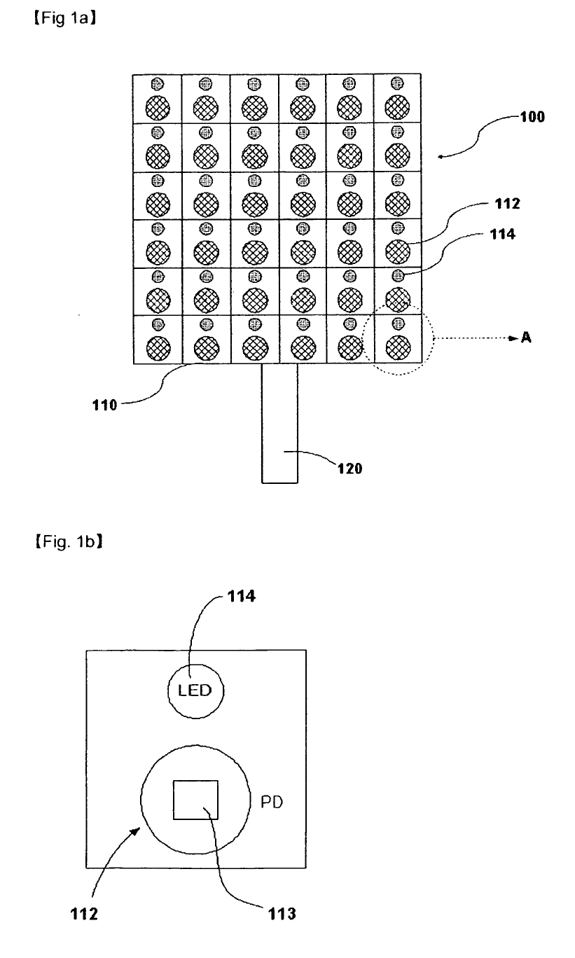

First, construction and function of the infrared ray detection board are illustrated. FIG. 1a˜FIG. 1c shows a construction of the infrared ray detection board. FIG. 1a shows an entire construction of the infrared ray detection board according to an embodiment of the present invention. And, FIG. 1b is an enlarged view of the area A shown in FIG. 1a. Moreover, FIG. 1c shows a block diagram of a circuit formed in the infrared ray detection board according to an embodiment of the present invention.

As shown in FIG. 1a, the infrared ray detection board 100 comprises the body 110 formed by a predetermined size board, a handle 120 for holding the infrared ray detection board 100 in hands so that the body 110 is toward the transmitter. Moreover, the light detector 112 and the LED 114 cling to the body 110 as a lattice form at a predetermined interval, with making a pair.

The light detector 112 is formed with a Silicone (Si), a Germanium (Ge), or an InGaAs according to a wavelength. And, it is preferable that a diameter of an effective detection region (FIG. 1b; 113) is large. Generally, the effective detection region 113 of the light detector is smaller than entire region 112 of the light detector. Moreover, the light emitted from the LED 114 is to be strong in proportion to an applied voltage.

A circuit is formed in a backside of the infrared ray detection board 100 for connecting the light detector 112 to the LED 114 with putting an amplifier 116 and a demodulation circuit 118 between the light detector 112 and LED 114, about each pair of the light detector 112 and the LED 114. In other words, the construction of the circuit, as shown in FIG. 1c, is formed as the light detector 112 is connected to the amplifier 116, and an output terminal of the amplifier 116 is connected to an input terminal of the demodulation circuit 118, an output terminal of the demodulation circuit 118 is connected to the LED 114.

The fundamental principle of the infrared ray detection board 100 according to the present invention is that strength of the light detected by the light detector 112 is indicated through the LED 114. Accordingly, one can know the arrived position of the laser light emitted by the transmitter at not only the receiver side but also the transmitter side which is departed with the receiver.

However, the rays of the sun, generally, comprise the infrared ray, so that in case that sensitivity of the light detector is high, the LED may be emitted by strong direct sunlight, although the infrared laser light is not inputted to the infrared ray detection board. Accordingly, in the present invention, the demodulation circuit is used to distinguish the light of the transmitter with the rays of the sun and other infrared rays inputted the outside.

The infrared ray detection board 100 according to the present invention detects signals through below steps.

First, the infrared laser light is strength-modulated to a predetermined frequency in the transmitter. Then, the modulated light is detected by the light detector 112 of the infrared ray detection board 100, and changed to an alternating electric signal. The alternating electric signal is detected as direct current signal by the demodulation circuit 118. The demodulation circuit 118 converts only signals having desired frequency, and removes the others. Accordingly, only signals having a frequency accorded with the modulation frequency of the transmitter are converted to DC signals, and the others are removed so that only the infrared rays emitted from the transmitter are detected, and lighten the LED 114. The amplifier 116 converts current signals outputted from the light detector 112 to voltage signals.

As the above description, one can know strength, range, and shape of the laser light by observing the brightness distribution of the LED 114 of the infrared ray detection board 110, because the brightness of the LED 114 is verified according to the strength of the laser light received in the effective detection region 113 of each light detector 112 mounted on the infrared ray detection board 100 as a lattice form.

Finally, the infrared ray detection board 100 according to the present invention can detect the position, shape and size of the laser light easier and faster than the infrared ray viewer. Moreover the infrared ray detection board 100 has an advantage that it has a wide range where the laser light can be detected.

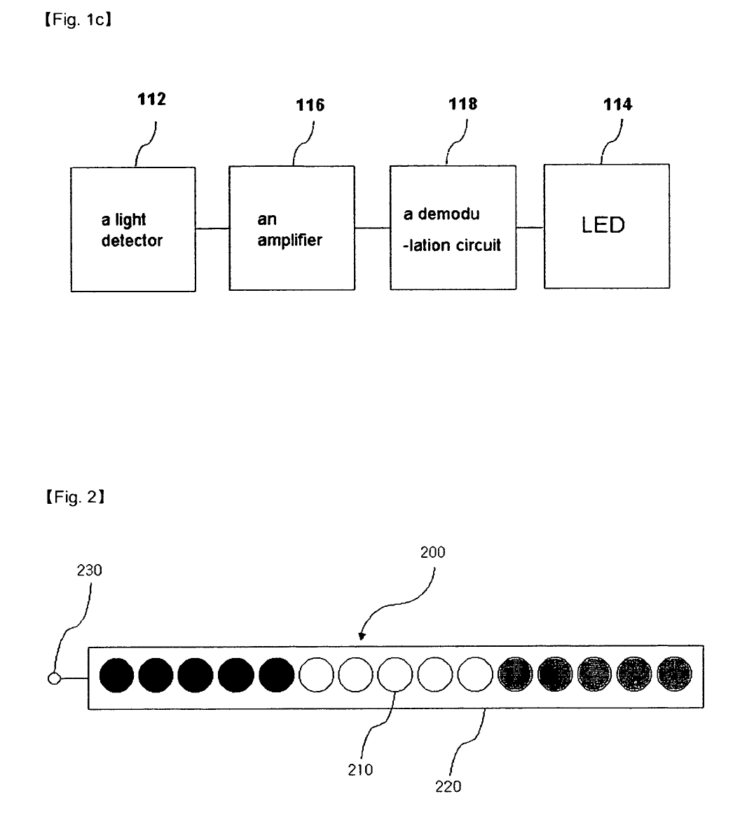

In below, the LED indicator 200 according to an embodiment of the present invention is illustrated. FIG. 2 shows the LED indicator 200 roughly according to an embodiment of the present invention. The LED indicator 200 is an apparatus for observing the strength of the laser light arrived to the receiver, at remote place, by connecting a LED bar formed with a plurality of LEDs 210 with a power-monitoring terminal of the receiver with a receiver connection terminal 230.

As shown in FIG. 2, a plurality of LEDs 210 is arranged in a line and mounted on the LED indicator 200, and forms LED bar. The number of LEDs that is lightened is changed according to an applied voltage. Further, the LED bar is mounted on the inside of a case 200 for making sun-ounds to be dark so as to confirm the light from the LEDs 210 easily, even if the outside of the LED bar is bright. One can confirm the number of lightened LEDs easily, by setting colors of the LEDs 210 used in the LED bar to be different, as shown in FIG. 2.

According to the present invention, one can correspond the center of the laser light to the light reception unit, accurately and easily, because he or she can know strength of the light received by the receiver with adjusting the transmitter at the transmitter side, by observing the LED indicator 200 of the receiver through a telescope or a sight telescope.

The infrared ray detection board 100 is useful to observe the position of the laser light roughly, and the LED indicator 200 is used to correspond the laser light to the light reception unit of the receiver accurately.

In below, three alignment methods that perform with these equipments are proposed according to an embodiment of the present invention.

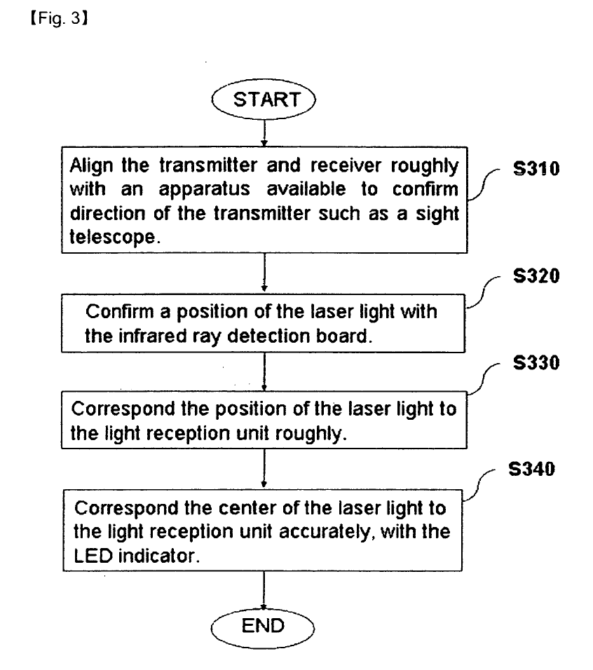

First, there is a manual alignment method, wherein alignment is performed by controlling screw or motor directly and manually. This method has below steps, as shown in FIG. 3.

a) Aligning the transmitter and receiver roughly with an apparatus available to confirm direction of the transmitter such as a sight telescope S310. This step is to prevent the laser light of the transmitter from getting out of the receiver far, and being not detected by the infrared ray detection board.

b) Confirming a position of the laser light by using the infrared ray detection board S320, and corresponding the position to the light reception unit roughly S330.

c) Corresponding the center of the laser light to the light reception unit accurately, with the LED indicator S340.

Second, there is an automatic alignment method wherein whole alignment process is performed by a computer, with a motor and motor controller that is controllable by the computer.

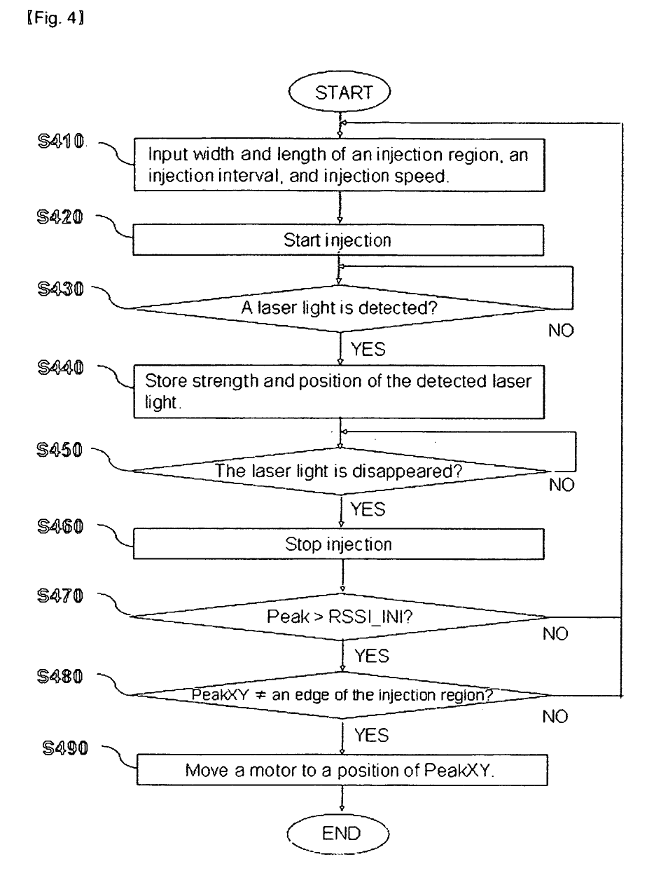

FIG. 4 shows the automatic alignment method according to an embodiment of the present invention.

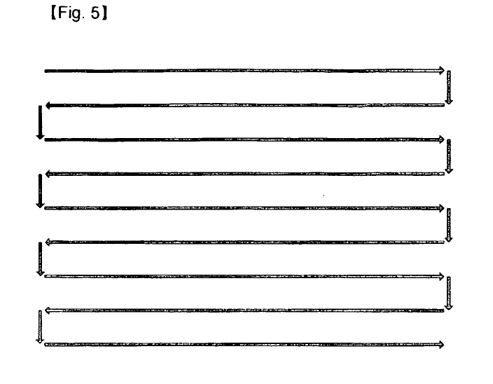

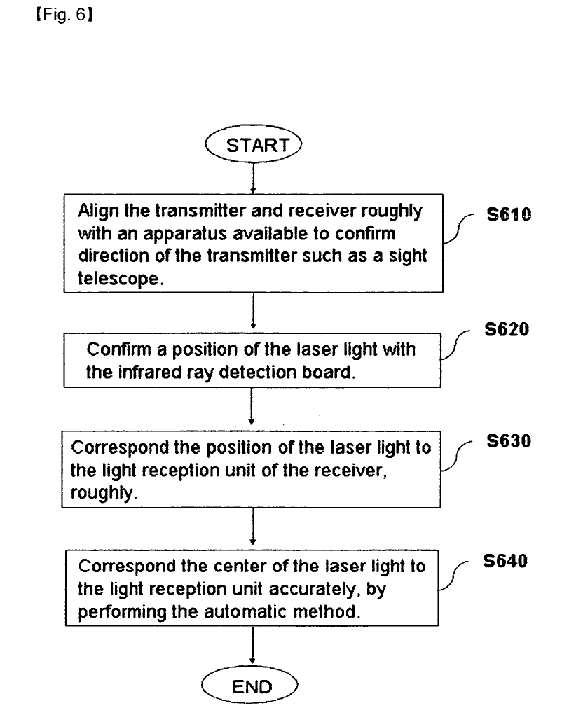

First, one designate width and length of an injection region, an injection interval, and injection speed after estimating position of the receiver widely S410, and starts injection S420. A raster scan method, shown in FIG. 5, is used as the injection method.

Electric signal (RSSI: Received Signal Strength Indicator) detected in a light strength detection terminal of the receiver is inputted to the motor controller or the computer through a general shortwave wireless communication or a wire communication.

If the laser light from the transmitter is inputted S430 during injection, one stores detected RSSI signal value and the position S440, and progresses injection, and stops injecting S460 in an injection line where the laser light disappears again S450.

Next, one judges that the peak of detected RSSI signal values is higher than a RSSI signal value (RSSI_INI) in case that the laser light is not inputted to the receiver S470. If the peak value is higher than the RSSI_IN, the laser light is received from the transmitter. Otherwise, one starts injection again by returning first step, because the laser light is not received from the transmitter.

Now, one judges that a detected injection position PeakXY is an edge of the injection region S480. If the PeakXY is at an edge of the injection region, one starts injection at other region by returning the first step, because a higher RSSI value may be detected at outside of the injection region.

If PeakXY is in the injection region not an edge of the injection region, it means that a reception point of the laser light is in the injection region. Therefore, alignment is finished by moving the transmitter to the PeakXY position with a motor.

If the laser light from the transmitter is not detected at the receiver side within the designated injection region, re-injection may be started with substantially same injection region, injection interval, and speed at adjacent part to the designated injection region (for example, just under part of the designated injection region), according to predetermined rule.

Third, there is a mixed alignment method by which alignment speed is improved. This method is performed by mixing the above mentioned manual alignment method and active alignment method. This method has below step.

First, corresponding the confirmed position of the laser light to the light deception unit of the receiver with the infrared detection board by performing step S610 to S630 corresponded to the steps S310 to S330 of the manual alignment method, for aligning roughly.

Next, corresponding the center of the laser light to the light reception unit of the receiver accurately S640, at the neighborhood of the position corresponded roughly, by performing the automatic alignment by method such as described in FIG. 4.

Basically, all of the pre-described three alignments methods are able to make alignment time to be short, and one can select and use one of the three methods.

The mixed alignment method has highest alignment speed although it's price is high owing to using the infrared ray detection board, the LED indicator, and the computer according to the present invention as alignment equipments, and has a trouble to move. One the other hand, in case of using the manual alignment method or the automatic alignment method, there is a merit that equipment for alignment is simple because the infrared ray detection board and the LED indicator, or only computer (in case of the automatic alignment method) are needed, although more time for alignment is required than the mixed alignment method. Accordingly, one can use one of these alignment methods in accordance with circumstance.

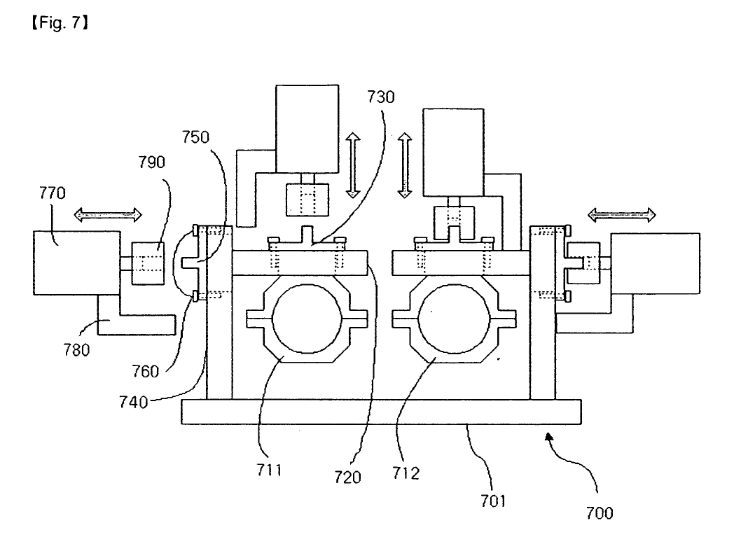

In the specification, a method for manufacturing an aligner that is cheap, light, and miniature is proposed. FIG. 7 shows construction of an aligner which is able to attach and remove a driver, according to an embodiment of the present invention.

As shown in FIG. 7, the aligner. 700 has two transmitter and receiver holders 711, 712 which makes a pair. The transmitter and receiver holder 711 shown in the left side of FIG. 7 is fixed to a turning board 730 for moving the transmitter and receiver holder 711 right and left, and whose vertical direction is fixed by a horizontal support member 720 for accepting a connection part of the transmitter and receiver holder 711 and the tuning board 730 to be movable right and left. The horizontal support member 720, is fixed to a turning board 750 for moving the transmitter and receiver holder 711 up and down, and whose horizontal direction is fixed by a vertical support member 740 for accepting a connection part of the support member 720 and the turning board 750 to be movable up and down. The vertical support member 740 is fixed again to a holding board 701 for holing entire construction. A transmitter and receiver holder 712 shown in right side of the FIG. 7 is fixed through substantially same method which is pre-described.

The turning board 750 for moving the transmitter and receiver 711 up and down may be connected to the motor coupler through a projection part, or fixed to the support member 740 by screw 760 of the both side. A motor 770 is connected to the backside of the connection part of a motor coupler 790 and the turning board 750. Moreover, the motor 770 is fixed by a motor holder 780.

In other words, the motor coupler 790 and the motor holder 780 are fixed to the turning board 750 and the support member 740, respectively, during alignment. In this state, one moves the transmitter and receiver holder 711 up and down by using the turning board 750, and fix the transmitter and receiver. When alignment is finished, one fixes the turning board 750 by using the screw 760. Thereafter, one removes the motor 770 by loosing the screw of the motor coupler 790 and the motor holder 780.

Although, moving the transmitter and receiver holder 711, shown in left side of FIG. 7, up and down is illustrated as an example of the alignment method, it is apparent to skilled person in the field to which the present invention pertains that a similar method may be used in cases of moving the transmitter and receiver holder 711 right and left, or moving another transmitter and receiver holder 712 up and down, or right and left. In other words, the motor may be attached or removed to the direction of an arrow shown in FIG. 7. In FIG. 7, two motors of left side show a state of being removed from the aligner, and two motors of right side show state of being mounted on the aligner.

In cast that alignment is swerved by the outside factor, or realignment is needed, one can realign by re-mounting motor, and moving the transmitter and receiver holder by loosening screws.

In this way, the motor and the motor holder is used repeatedly in a plurality of aligners, by making the motor and the motor holder to be attachable and removable. Therefore, the expense for manufacturing aligner is low, and the aligner is light, and small.

Although the present invention has been described in considerable detail with reference to certain preferred versions thereof, other versions are possible. Therefore, the sprit and scope of the appended claims should not be limited to the description of the preferred versions contained herein.

### INDUSTRIAL APPLICABILITY

According to the present invention, the transmitter and receiver can be aligned easily and rapidly in the optical communication system as alignment can be performed at the transmitter side directly, without indication of the receiver though by wireless.

Moreover, an aligner can be manufactured to be small and cheap as a driver is removed after alignment and fixation.

Furthermore, when alignment of the aligner is swerved by the outside factors, the transmitter and receiver can be realigned by re-mounting the driver.

1. A light detection apparatus comprising:
a board;
a plurality of light detectors for detecting a light from the outside of the board, wherein the light detectors are formed on the board;
a plurality of LEDs for receiving a signal which indicates strength of the light which is detected by the light detectors and indicating it visually, wherein the LEDs are formed on the board.

2. The light detection apparatus of claim 1, wherein the LEDs are connected to the light detectors, respectively.

3. The light detection apparatus of claim 1, further comprising a plurality of amplifiers for converting current signals outputted from the light detectors to voltage signals, respectively.

4. The light detection apparatus of claim 1, further comprising a plurality of demodulation circuits for converting only signals of predetermined frequency to direct current signals,
wherein the demodulation circuits receive signals from the amplifiers, respectively, and transmit the converted signals to the LEDs, respectively.

5. The light detection apparatus of claim 3 or 4, wherein the amplifiers, or the demodulation circuits, or all of the amplifiers and the demodulation circuits are formed at the opposite side of a side where the light detector and the LEDs are formed.

6. The light detection apparatus of claim 1, wherein the light detectors can detect light of the infrared region.

7. The light detection apparatus of claim 1, wherein the light detectors are used to align a transmitter and receiver used in the optical wireless communication system.

8. The light detection apparatus of claim 1, wherein the light detectors make a pair with the LEDs, respectively.

9. The light detection apparatus of claim 8, wherein each the light detector and the LED that make a pair, is arranged with a lattice form.

10. A light strength indication apparatus comprising:
a reception terminal for inputting an electric signal from the outside; and
a plurality of LEDs for indicating strength of the signal received through the reception terminal, and
wherein the number of lightened LEDs are verified in proportion to the strength of the signal received through the reception terminal, and
wherein the reception terminal can receive the light strength signal from the light receiver by connecting to a power monitoring terminal of an optical receiver used in an optical the wireless communication system, and can receive.

11. The light strength indication apparatus of claim 10, wherein the LEDs are arranged in a line.

12. The light strength indication apparatus of claim 10, wherein the LEDs are mounted in a case for making surround of the LEDs be darker than the outside of the light strength indication apparatus.

13. The light strength indication apparatus of claim 10, wherein the LEDs comprise 2 or more LEDs that can indicate at least 2 colors.

14. An alignment method for aligning a transmitter and receiver in the optical wireless communication system comprising the steps of:
corresponding a position of the receiver where a light outputted from the transmitter is arrived, to a light reception unit of the receiver, roughly, by detecting the position of the receiver from brightness distribution of first diodes with a light detection apparatus comprising a board, a plurality of light detectors for detecting light from the outside of the board, wherein the light detectors formed on the board, and a plurality of first LEDs for receiving a signal which indicates strength of the light detected by the light detectors and indicating it visually, wherein the first LEDs are formed on the board; and
corresponding a center of a laser light from the transmitter to the light reception unit of the receiver, by detecting the center of the laser light from the number of second LEDs which are lightened, with a light strength indication apparatus comprising a reception terminal for inputting electric signals from a light strength detection terminal by connecting to the light strength detection terminal of the receiver, a plurality of second LEDs for indicating strength of the signal received through the reception terminal, wherein the number of second LEDs are lightened is verified in proportion to the strength of the signal received through the reception terminal.

15. The alignment method of claim 14, wherein in the first step, a position of the light detector corresponding to the first LED which is brightest of the plurality of first LEDs is detected as the position of the receiver where the laser light from the transmitter is arrived.

16. The alignment method of claim 14, wherein in the second step, a position of the laser light is detected as the center of the laser light, when most number of the second LEDs is lightened.

17. An alignment method for aligning a transmitter and receiver in an optical wireless communication system by using a computer that can receive and process a signal indicating strength of a light received by the receiver, comprising the steps of:
designating an injection range, interval, and speed of a laser light from the transmitter;
transmitting the signal indicating strength of the light to the computer, as injection is started by designated injection range, intervals, and speed;
judging whether the laser light from the transmitter is received to the receiver;
storing an injection position and received signal value in case that the laser light is received to the receiver;
judging whether reception of the laser light is discontinued;
discontinuing injection in case that reception of the laser light is judged to be discontinued in the fifth step of judging;
determining a position where the received signal value is peak of received signals between the injection position stored in the fourth step and the injection discontinued position in the sixth step; and
moving the transmitter to the position where the received signal value is peak.

18. The alignment method of claim 17, after the seventh step of determining, comprising the step of judging whether the position where the received signal value is peak is at an edge of the injection region; and
the step of re-designating the injection region, when the position where the received signal value is peak is at an edge, to adjacent to the edge of the injection range comprising the position where the received signal value is peak, and repeating the second step to the eighth step.

19. The alignment method of claim 17, wherein in the third step the laser light from the transmitter is judged to be received to the receiver in case that the light strength indication signal exceeds a predetermined value.

20. The alignment method of claim 17, wherein in the fifth step the reception of the laser light is judged to be discontinued in case that the light strength indication signal is below a predetermined value.

21. An alignment method for aligning a transmitter and receiver in an optical wireless communication system comprising the steps of:
corresponding a position of the receiver where a laser light from the transmitter is arrived, to a light reception unit of the receiver, roughly, and determining a predetermined range comprising the position by detecting the position of the receiver through brightness distribution of first diodes by using a light detection apparatus comprising a board, a plurality of light detectors, formed on the board, for detecting a light from the outside of the board, and a plurality of first LEDs, formed on the board, for receiving a signal indicating strength of the light detected by the light detectors and indicating the signal visually;
transmitting the signal indicating strength of the laser light received to the receiver to the computer, as injection is started to the injection range which is determined by the first step, with predetermined injection intervals, and speed;
judging whether the laser light from the transmitter is received to the receiver;
storing the injection position and received signal value in case that the laser light is received to the receiver;
judging whether reception of the laser light is discontinued;
discontinuing injection in case that reception of the laser light is discontinued;
determining position where the received signal value is peak of the received signals between the injection position stored in the fourth step and the injection discontinued position in the sixth step; and
moving the transmitter to the position where the received signal value is peak.

22. An aligner for a transmitter and receiver comprising:
a holder for the transmitter and receiver; and
means for moving the transmitter and receiver, wherein the means is disposed to verify and fix a position of the holder to a predetermined direction, and
wherein the means for moving the transmitter and receiver further comprises means for fixing a connection unit for connecting with an external driver and the position of the holder, and
wherein the position of the holder can be verified to a predetermined direction by using the driver in the state of being connected to the external driver by the connection unit, and
wherein the driver may be removed after fixing the holder by using the means for fixing the connection unit.

23. The aligner for a transmitter and receiver of claim 22, wherein the means for moving the transmitter and receiver is not less than two.

24. The aligner for a transmitter and receiver of claim 22, wherein the predetermined direction is up and down, or right and left.
